(19) United States
(12) Patent Application Publication
(10) Pub. No.: US 2024/0174110 A1
(43) Pub. Date: May 30, 2024

(54) AUGMENTING CHARGING STATION OPTIMIZATION WITH VEHICLE TELEMATICS

(71) Applicant: PowerFlex Systems, LLC, San Diego, CA (US)

(72) Inventor: Zachary Jordan LEE, Altadena, CA (US)

(21) Appl. No.: 18/357,123

(22) Filed: Jul. 23, 2023

Related U.S. Application Data
(60) Provisional application No. 63/428,820, filed on Nov. 30, 2022.

(51) Int. Cl. B60L 53/62; B60L 53/66; B60L 53/68

(52) U.S. Cl. CPC B60L 53/62; B60L 53/665; B60L 53/68; B60L 2240/62

(57) ABSTRACT

Certain aspects of the present disclosure provide techniques for a method of managing charging of vehicles, comprising: estimating a vehicle return state based on telematics data associated with a vehicle; determining a future charging session for the vehicle based on the vehicle return state and one or more of: a vehicle attribute; a job attribute; and a station attribute; generating a hybrid set of charging sessions by adding the future charging session to a set of one or more current charging sessions; and processing the hybrid set of charging sessions with a charging management algorithm to determine one or more charging session attributes for each charging session in the hybrid set of charging sessions.

### CROSS REFERENCE

This application claims the benefit of U.S. provisional application Ser. No. 63/428,820, filed on Nov. 30, 2022, which is hereby incorporated by reference in its entirety.

### INTRODUCTION

Aspects of the present disclosure relate to systems and methods for improving optimization of charging stations based on electric vehicle telematics.

Electric vehicles, including plug-in hybrid and fully electric vehicles, are increasing in popularity around the world. It is expected that the proportion of new electric vehicles sold each year out of the total number of vehicles sold will continue to rise for the foreseeable future. Moreover, while electric vehicle operators are primarily non-commercial at present (e.g., personal vehicles), commercial vehicle operators are increasingly adding electric vehicles to their fleets for all sorts of commercial operations, thus adding to the number of electric vehicles in operation throughout the world.

The shift from internal combustion engine-powered vehicles to electric vehicles requires significant supporting infrastructure anywhere electric vehicles are operated. For example, electric vehicle charging stations, sometimes referred to as electric vehicle supply equipment, need to be widely distributed so that operators of electric vehicles are able to traverse the existing roadways without issue.

Optimizing the performance of electric vehicle charging stations is a complex problem faced in the transition to widespread electric vehicle adoption. The complexity is derived from many aspects of the problem, including variable capabilities of electric vehicle charging stations, variable capabilities of electric vehicles, variable availabilities of electric vehicle charging stations and electric vehicles throughout the day, variable electricity rates and cost structures throughout the day, and variable underlying electrical infrastructure at charging sites, to name just a few considerations.

Certain optimization techniques have been tried for matching electric vehicle charging tasks to electric vehicle charging equipment and for assigning charging rates to individual vehicles based on their charging task at a given charging site; however, such techniques have been generally limited to static environments. For example, it may be possible to solve an optimization problem for a known number and type of electric vehicles given a known number and type of electric vehicle chargers with certain time objectives. However, such optimization solutions are rapidly invalidated in dynamic environments, such as real world environments in which electric vehicles are coming and going from charging sites continuously.

Accordingly, there is a need for improved methods for optimizing charging of electric vehicles.

### SUMMARY

Certain embodiments provide a method of managing charging of vehicles, comprising: estimating a vehicle return state based on telematics data associated with a vehicle; determining a future charging session for the vehicle based on the vehicle return state and one or more of: a vehicle attribute; a job attribute; and a station attribute; generating a hybrid set of charging sessions by adding the future charging session to a set of one or more current charging sessions; and processing the hybrid set of charging sessions with a charging management algorithm to determine one or more charging session attributes for each charging session in the hybrid set of charging sessions.

Other embodiments provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the related drawings set forth in detail certain illustrative features of one or more embodiments.

### DESCRIPTION OF THE DRAWINGS

The appended figures depict certain aspects of the one or more embodiments and are therefore not to be considered limiting of the scope of this disclosure.

FIG. 1A depicts an example flowchart of a method for optimizing charging of electric vehicles based on vehicle telematics.

FIG. 1B depicts another example flowchart of a method for optimizing charging of electric vehicles based on vehicle telematics.

FIG. 2 depicts an example method for optimizing charging of electric vehicles based on vehicle telematics.

FIG. 3 depicts an example processing system configured to perform the methods described herein.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for improving optimization of charging stations based on electric vehicle telematics.

Optimizing the behavior of electric vehicle charging stations is classically difficult due to the multivariate nature of the problem. Conventionally, such optimization has only been attempted for relatively static charging scenarios. An example of such a scenario is when a known set of vehicles (e.g., a commercial fleet of electric vehicles) are charged with a known set of charging stations (e.g., at a fleet headquarters) over a known time interval (e.g., overnight each day). Optimizing the charging of the set of vehicles in the aforementioned scenario is a complex, but tractable problem, given the various constraints and assumptions. Now consider another scenario in which the set of charging stations is known, but the set of vehicles and the timing of charging is dynamic, such as a fleet of rental electric vehicles that may be rented and returned in both scheduled and unscheduled fashions. Traditional charging optimization techniques simply cannot handle the increased complexity of such a scenario, and the existing optimizations may be rapidly invalidated based on unscheduled arrivals and departures of electric vehicles.

Thus, a technical problem exists in the art in which existing charging optimization techniques, such as adaptive load management techniques, only optimize for electric vehicles that are presently connected to charging stations at a given charging site. However, as above, many real world scenarios exist in which optimization performance measures, such as cost, readiness, and reliability, could be improved if the optimization technique considered not only vehicles currently connected to charging stations, but also vehicles that are likely to be connected to and/or disconnected from charging stations soon.

Accordingly, embodiments described herein are directed to a charging management system that improves its charging optimization based on knowledge of vehicles' telematics. For example, embodiments may predict a vehicle's arrival time at a charging site and its state of charge upon arriving at the charging site based on knowledge of, for example, a route the vehicle is following (e.g., a delivery route) and a current position of the vehicle. The future arrival and state of such a vehicle may thus be included in the optimization problem along with currently charging vehicles, which improves, for example, scheduling assignments of vehicles and power to charging stations at various times. Optimizing future charging sessions based on future arrival times of electric vehicles is thus a technical solution that overcomes technical limitations of existing, simpler metric-based algorithms, like first-come, first-served, earliest-deadline-first, or least-laxity-first algorithms. The benefits of embodiments described herein include improved vehicle readiness, reduced charging cost, and better visibility for electric vehicle fleet operators into their fleet charging needs.

### Optimizing Charging of Electric Vehicles Based on Vehicle Telematics

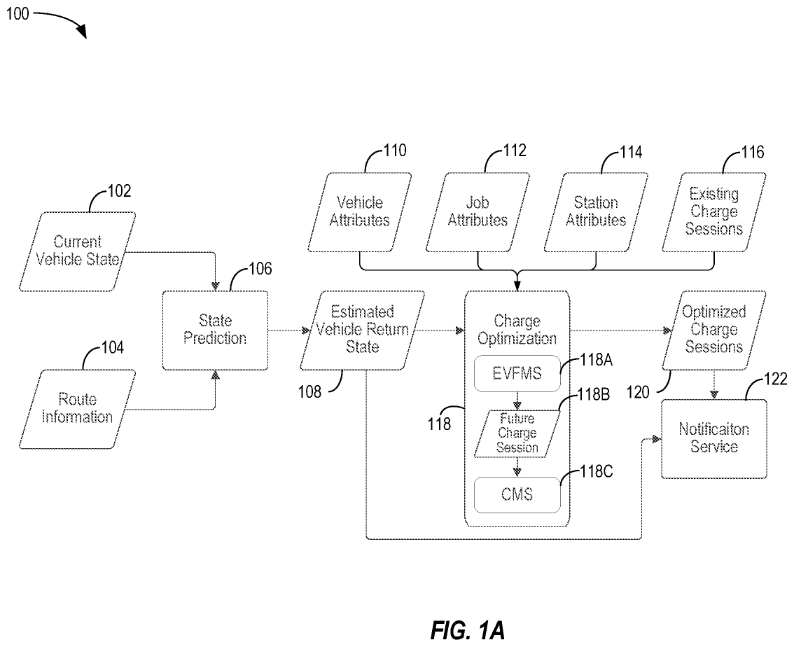

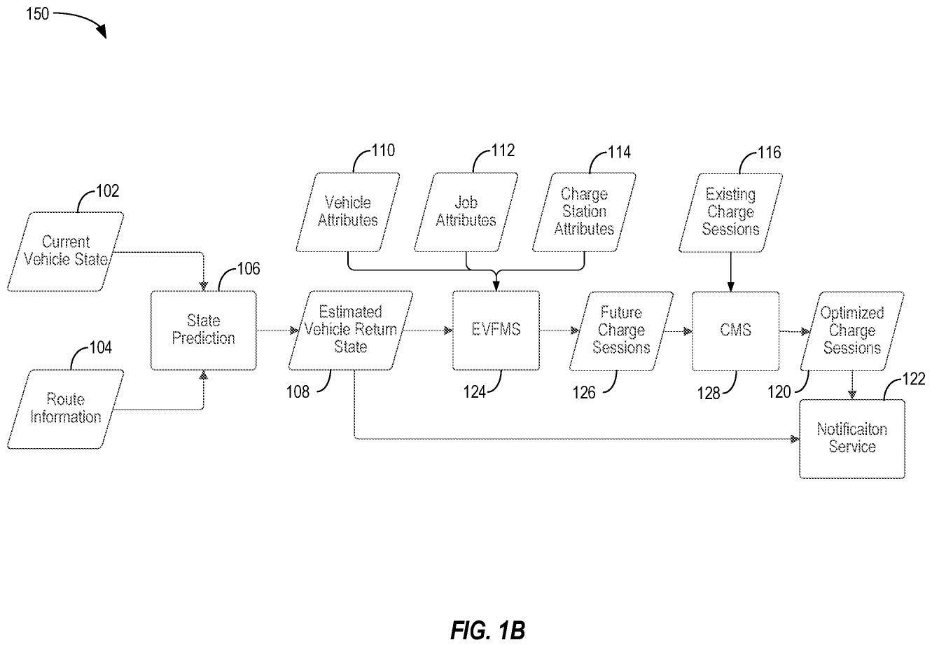

FIG. 1A depicts an example flowchart 100 of a method for optimizing charging of electric vehicles based on vehicle telematics.

Initially, a current vehicle state 102 and route information 104 are provided to a state prediction element 106, which generates an estimated vehicle return state 108. In various embodiments, a vehicle state 102 (e.g., current or future) may be defined by various vehicle state attributes, such as: state of charge of the vehicle's electric storage device (e.g., battery), energy capacity of the vehicle's electric storage device, estimated range, location, assigned route, current environmental conditions (e.g., indoor and outdoor temperature), current operating settings (e.g., heating, ventilation, air conditioning, lights, window positions, number of persons onboard, cruise control speed, etc.) and a driver profile, to name just a few examples. An estimated return state 108, an example of a future vehicle state, may include values for any of the aforementioned current vehicle states 102. For example, estimated return state 108 may relate to the state of a rental or delivery vehicle upon returning to a rental lot or a delivery vehicle depot. The various vehicle state attributes may more generally be considered vehicle telematics, which may be shared with systems, such as state prediction element 106 through various communication means, including through, for example, cellular networks, local area networks, and personal area networks directly from the vehicle, or through third party providers via application programming interfaces (APIs) and through other cloud data services.

In various embodiments, route information 104 may include, for example, waypoints, time spent at visited waypoints, expected time to be spent at future waypoints, expected time of arrival at destination, expected vehicle load for each segment (e.g., defined between two waypoints), traffic along route segments (both current and future), and others.

Estimated return state 108 is provided to a charge optimization element 118, which in this embodiment may implement (or be implemented within) the functionality of an electric vehicle fleet management system (EVFMS) and/or a charge management system (CMS).

Generally, EVFMS 118A uses the estimated vehicle return state 108, vehicle attributes 110, a list of jobs 112, and station attributes 114, to determine parameters for a future charging session 118B for the vehicle.

An electric vehicle charging session may generally be considered a period of time in which an electric vehicle is plugged into a charging station, which may be characterized by various charging session attributes based on the charging station and the electric vehicle being charged, including: an estimated and actual start time for the respective charging session; a target and actual energy level at an end of the charging session; an estimated and actual end time for the charging session; a maximum available and used charging rate for the charging session; a maximum charging voltage available and used for the charging session; a time-series of charging rates scheduled and used during the charging session; a total energy estimated to be and actually delivered during the charging session; a difference between a target energy level and a final energy level during the charging session; an estimated and actual idle time of the vehicle during the charging session; an estimated and actual cost of the respective charging session, and others. Further, when considering charging multiple electric vehicles, such as at an electric vehicle charging site, further charging session attributes may include a charging station assignment for a charging session; a job identifier for a charging session; and an indication of any station swaps caused by the charging session. A future charging session is a charging session planned for a vehicle that is not yet plugged into a charging station.

Vehicle attributes 110 may generally include any sort of characteristic of a vehicle, such as the vehicle class, the vehicle make, the vehicle model, the vehicle's physical dimensions (e.g., height, width, length.), the vehicle's unladen weight, a vehicle department, a vehicle maintenance status, a battery capacity, a maximum charging rate, a charging connector type, a maximum range, cargo capacity (e.g., by volume and/or weight), a towing capacity, a passenger capacity, specific equipment fitted to the vehicle, and others.

A job is generally a task a vehicle needs to complete, which may be defined by various job attributes 112, such as charging session attributes (e.g., a target energy level at an end of the respective charging session and an estimated end time for the respective charging session) and vehicle attributes, as described above.

Charging station attributes 114 may generally include, for example, type of charging connector(s) available, charging rate(s) and/or power levels available (e.g., Level 1, 2, etc.), current availability (e.g., plugged-in and charging, plugged-in and idle, unoccupied, and others), adjacent parking space attributes, such as dimensions and accessibility, and others.

EVFMS 118A determines a future charging session 118B for a vehicle that is remote from the charging site based on, for example, its estimated vehicle return state 108, which allows for improved optimization by charge optimization component 118. The future charging session 118B for the vehicle is combined with existing charging sessions 116 to form a hybrid set of charging sessions (e.g., a set of charging sessions that includes current charging sessions and future charging sessions). The hybrid set of charging sessions is then processed by CMS 118C to determine attributes for a set of optimized charging sessions 120, which may generally include a schedule of charging rates for each of the charging sessions in the hybrid set of charging sessions (where each charging session is associated with a particular vehicle).

Charge optimization element 118, and in some cases CMS 118C, may implement a charging management algorithm, which is generally an algorithm that takes as inputs one or more vehicle return states, and a subset of input charging session attributes and determines a subset of output charging session attributes. For example, the input charging session attributes may include arrival time at charging site, state of charge upon arrival, energy capacity upon arrival, target energy level at departure, estimated session end time, and/or a charging station assignment. The output charging session attributes may include, for example, a time-series of charging rates, an estimated amount of energy to be delivered, an estimated idle, and/or an estimated session cost.

In some cases, the optimized charging sessions 120 determined by CMS 118C may affect existing charging sessions 116 at a charging site, such as delaying or rescheduling charging sessions, changing the time-series of charging rates, and the like. In such cases, an alert may be sent to an affected user (or users), such as a fleet manager, based the new optimized charging sessions 120. For example, the notification service 122 may determine notifications that need to be sent based on a comparison of the current optimized charging sessions 120 to the existing charging sessions 116 (or some other set of charging sessions), or based on a prompt from charge optimization element 118, including a prompt from CMS 118C

In the example depicted in FIG. 1A, the role of EVFMS 118A and CMS 118C are combined into a single optimization problem solved by charge optimization element 118 in which charging session assignments and charging rate assignments are jointly decided as part of an optimization problem. FIG. 1B, discussed further below, depicts an alternative arrangement in which separate EVFMS and CMS functions and optimizations are performed.

In some cases, CMS 118C is configured so that future charging sessions (e.g., 118B) receive lower priority than existing charging sessions 116 when there is not enough electrical capacity to meet all energy demands.

In some cases, EVFMS 118A may be configured so that a vehicle is preassigned a specific job and/or charging station. In some cases, EVFMS 118A may be configured to assign jobs and/or charging stations based on statistical models of past behavior.

Notification service 122 may generally send a variety of types of notifications, such as a charging session has unmet demand, a charging session finished charging time is later than deadline, a charging session cost exceeds limit, or a charging station reassignment (e.g., a swap). For example, a charging station reassignment may be made to move one vehicle from a higher level (e.g., faster, higher-power) charging station to a lower-level (e.g., slower, lower-power) charging station based on a new optimization solution. In some cases, the notification service 122 may generate a notification based on the estimated vehicle return state 108, such as when the estimated vehicle return state (e.g., time and state of charge) differ by more than some threshold (e.g., a percentage or discrete amount) from the actual vehicle return state.

Note that while the example in FIG. 1A depicts state prediction element 106 using both current vehicle state 102 and route information 104 for prediction of estimated vehicle return state 108, in other embodiments, state prediction element 106 may use a subset of this information, additional information, and the like. For example, state prediction element 106 may not have route information 104, but may be able to predict estimated vehicle return state based on historical norms, driver profiles, time of day, and the like. Though not depicted in FIG. 1A, state prediction element 106 may include various sub-elements, such as a route prediction sub-element, a traffic prediction sub-element, a weather prediction sub-element, a vehicle-specific battery discharge model, and various other sub-elements that are useful for predicting estimated vehicle return state 108.

FIG. 1B depicts another example flowchart 150 of a method for optimizing charging of electric vehicles based on vehicle telematics.

Generally, all like numbered aspects of FIG. 1B are as described in FIG. 1A. However, in FIG. 1B, rather than a single optimization element, there is a standalone EVFMS 124 and CMS 128. Generally, the functions of EVFMS 124 are like those of EVFMS 118A described in FIG. 1A, and the functions of CMS 128 are like those of CMS 118C in FIG. 1A.

### Example Method for Optimizing Charging of Electric Vehicles Based on Vehicle Telematics

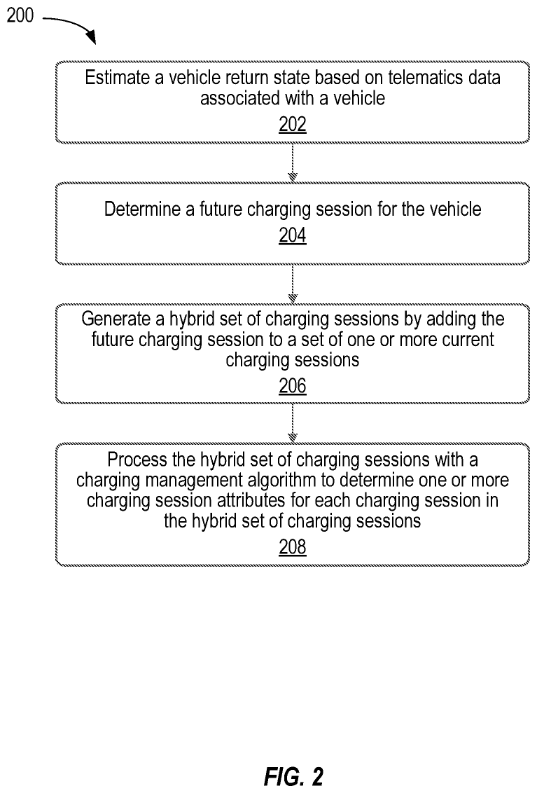

FIG. 2 depicts an example method 200 for optimizing charging of electric vehicles based on vehicle telematics.

Method 200 begins at step 202 with estimating a vehicle return state (e.g., 108 in FIGS. 1A and 1B) based on telematics data associated with a vehicle. For example, the telematics may include various vehicle state attributes, such as 102 in FIG. 1.

Method 200 then proceeds to step 204 with determining a future charging session (e.g., 118B of FIG. 1A and 126 of FIG. 1B, for the vehicle. In some embodiments, the determination is based on the vehicle return state and one or more of: a vehicle attribute; a job attribute; and a station attribute.

Method 200 then proceeds to step 206 with generating a hybrid set of charging sessions by adding the future charging session to a set of one or more current charging sessions.

Method 200 then proceeds to step 208 with processing the hybrid set of charging sessions with a charging management algorithm to determine one or more charging session attributes for each charging session in the hybrid set of charging sessions.

In some embodiments, the vehicle return state comprises one or more attributes, including one or more of: an estimated arrival time of the vehicle at a charging location; and an estimated energy level of the vehicle at the estimated arrival time.

In some embodiments, the estimated energy level comprises a state of charge of an energy storage device in the vehicle.

In some embodiments, the estimated energy level comprises a number of kilowatt hours stored in an energy storage device in the vehicle.

In some embodiments, the estimated energy level comprises the remaining range of the vehicle in miles or kilometers.

In some embodiments, the charging session attributes for each respective charging session in the hybrid set of charging sessions comprise one or more of: an estimated start time for the respective charging session; a target energy level at an end of the respective charging session; an estimated end time for the respective charging session; a charging station assignment for the respective charging session; a job identifier for the respective charging session; a maximum charging rate for the respective charging session; and a maximum charging voltage for each charging session.

In some embodiments, method 200 further includes determining, by the charging management algorithm, one or more charging session attributes for each respective charging session in the hybrid set of charging sessions, including one or more of: a time-series of charging rates during the respective charging session; a total energy to be delivered during the respective charging session; a difference between a target energy level and a final energy level during the respective charging session; an estimated idle time of the vehicle during the respective charging session; an estimated cost of the respective charging session; and an indication of any station swap caused by the respective charging session.

In some embodiments, the charging management algorithm comprises an optimization algorithm. In some embodiments, the optimization algorithm comprises an adaptive load management algorithm.

In some embodiments, the telematics data associated with the remote vehicle comprises one or more of: a current location of the vehicle; a current energy level of the vehicle; a remaining range of the vehicle; a current payload of the vehicle; an ambient temperature around the vehicle; a temperature setpoint of the interior of the vehicle; and a driver profile associated with the vehicle.

In some embodiments, method 200 further includes assigning the vehicle to a job and/or a charging station based on output from the charging management algorithm.

In some embodiments, method 200 further includes assigning the vehicle to a job and/or a charging station using an assignment heuristic.

In some embodiments, method 200 further includes conducting each charging session in the hybrid set of charging sessions according to the charging session attributes determined by the charging management algorithm.

In some embodiments, method 200 further includes, determining a route for the vehicle to traverse to arrive at the charging location, wherein: determining the estimated arrival time of the vehicle at the charging location is based on the route; and determining the estimated energy level of the vehicle at the estimated arrival time is based on the route.

In some embodiments, method 200 further includes determining traffic along the route, wherein: determining the estimated arrival time of the vehicle at the charging location is based on the traffic along the route; and determining the estimated energy level of the vehicle at the estimated arrival time is based on the traffic along the route.

In some embodiments, the route includes one or more waypoints between a current location of the vehicle and the charging location. In some embodiments, the route is a direct route between a current location of the vehicle and the charging location without intervening waypoints.

In some embodiments, the estimated arrival time of the vehicle at the charging location is based on a current time of day.

In some embodiments, method 200 further includes determining an actual arrival time of the vehicle at the charging location; and sending a notification based on the actual arrival time differing from the estimated arrival time by more than a threshold amount of time.

In some embodiments, method 200 further includes determining an actual energy level of the vehicle at the charging site; and sending a notification based on the actual energy level differing from the estimated energy level by more than a threshold amount.

In some embodiments, method 200 further includes sending a notification after determining that at least one charging session in the hybrid set of charging sessions will fail to meet a charging session objective. In some embodiments, the charging session objective comprises an energy level by a target time.

Note that method 200 is just one example, and other methods including fewer, additional, or alternative steps, consistent with this disclosure, are possible.

### Example Processing System for Optimizing Charging of Electric Vehicles Based on Vehicle Telematics

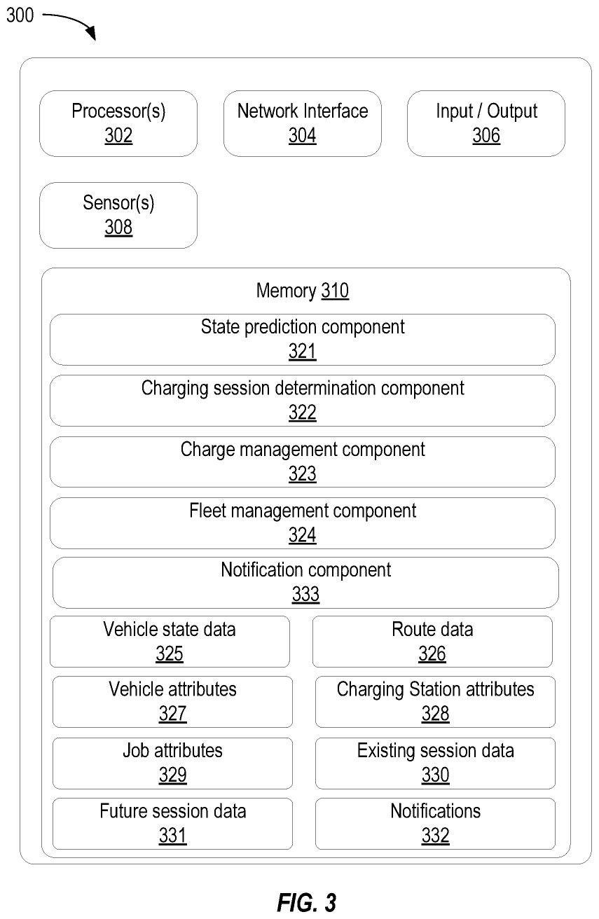

FIG. 3 depicts an example processing system 300 configured to perform the methods described herein.

Processing system 300 includes one or more processors 302. Generally, a processor 302 is configured to execute computer-executable instructions (e.g., software code) to perform various functions, as described herein.

Processing system 300 further includes a network interface 304, which generally provides data access to any sort of data network, including personal area networks (PANs), local area networks (LANs), wide area networks (WANs), the Internet, and the like.

Processing system 300 further includes input(s) and output(s) 306, which generally provide means for providing data to and from processing system 300, such as via connection to computing device peripherals, including user interface peripherals.

Processing system 300 further includes one or more sensors 308. For example, sensors 308 may include image sensors, proximity sensors, presence sensors, and other types of sensors as described herein.

Processing system 300 further includes a memory 310 comprising various components. In this example, memory 310 includes a state prediction component 321 (such as component 106 of FIG. 2), a charging session determination component 322 (e.g., component 118 of FIG. 1A and 124 and 128 of FIG. 1B), a charge management component 323 (e.g., component 118C of FIG. 1A and 128 of FIG. 1B), a fleet management component 324 (e.g., component 118A of FIG. 1A and 124 of FIG. 1B), a notification component 333 (e.g., 122 of FIGS. 1A and 1B), vehicle state data 325 (e.g., 102 in FIGS. 1A and 1B), route data 326 (e.g., 104 in FIGS. 1A and 1B), vehicle attributes 327 (e.g., 110 in FIGS. 1A and 1B), charging station attributes 328 (e.g., 114 in FIGS. 1A and 1B), job attributes 329 (e.g., 112 in FIGS. 1A and 1B), existing session data 330 (e.g., 116 in FIGS. 1A and 1B), future session data 331 (e.g., component 118B of FIG. 1A and 126 of FIG. 1B), and notifications 332.

Processing system 300 may be implemented in various ways. For example, processing system 300 may be implemented within on-site, remote, or cloud-based processing equipment. Note that in various implementations, certain aspects may be omitted, added, or substituted from processing system 300. It should be understood that while some components are described herein as being run in the cloud or in the edge, this is merely one example. Depending on the particular embodiment, components such as the charge management component 323 may be run either in the cloud or edge.

### EXAMPLE CLAUSES

Implementation examples are described in the following numbered clauses:

Clause 1: A method of managing charging of vehicles, comprising: estimating a vehicle return state based on telematics data associated with a vehicle; determining a future charging session for the vehicle based on the vehicle return state and one or more of the following: a vehicle attribute; a job attribute; or a station attribute; generating a hybrid set of charging sessions by adding the future charging session to a set of one or more current charging sessions; and processing the hybrid set of charging sessions with a charging management algorithm to determine one or more charging session attributes for each charging session in the hybrid set of charging sessions.

Clause 2: The method of clause 1, wherein the vehicle return state comprises one or more attributes, including one or more of the following: an estimated arrival time of the vehicle at a charging location; or an estimated energy level of the vehicle at the estimated arrival time.

Clause 3: The method of clause 1 and/or 2, wherein the estimated energy level comprises at least one of the following: a state of charge of an energy storage device in the vehicle, a number of kilowatt hours stored in an energy storage device in the vehicle, or the remaining range of the vehicle in miles or kilometers.

Clause 4: The method of any of clauses 1 through 3, wherein the charging session attributes for each respective charging session in the hybrid set of charging sessions comprise one or more of the following: an estimated start time for the respective charging session; a target energy level at an end of the respective charging session; an estimated end time for the respective charging session; a charging station assignment for the respective charging session; a job identifier for the respective charging session; a maximum charging rate for the respective charging session; or a maximum charging voltage for each charging session.

Clause 5: The method of any of clauses 1 through 4, further comprising determining, using the charging management algorithm, one or more charging session attributes for each respective charging session in the hybrid set of charging sessions, including one or more of the following: a time-series of charging rates during the respective charging session; a total energy to be delivered during the respective charging session; a difference between a target energy level and a final energy level during the respective charging session; an estimated idle time of the vehicle during the respective charging session; an estimated cost of the respective charging session; or an indication of any station swap caused by the respective charging session.

Clause 6: The method of any of clauses 1 through 5, wherein the charging management algorithm comprises at least one of the following: an optimization algorithm or an adaptive load management algorithm.

Clause 7: The method of any of clauses 1 through 6, wherein the telematics data comprises one or more of the following: a current location of the vehicle; a current energy level of the vehicle; a remaining range of the vehicle; a current payload of the vehicle; an ambient temperature around the vehicle; a temperature setpoint of the interior of the vehicle; or a driver profile associated with the vehicle.

Clause 8: The method of any of clauses 1 through 7, further comprising assigning the vehicle to at least one of the following: a job or a charging station, based on output from the charging management algorithm.

Clause 9: The method of any of clauses 1 through 8, further comprising conducting each charging session in the hybrid set of charging sessions according to the charging session attributes determined by the charging management algorithm.

Clause 10: The method of any of clauses 1 through 9, further comprising: determining a route for the vehicle to traverse to arrive at the charging location, wherein: determining the estimated arrival time of the vehicle at the charging location is based on the route; and determining the estimated energy level of the vehicle at the estimated arrival time is based on the route.

Clause 11: The method of any of clauses 1 through 10, further comprising: determining traffic along the route, wherein: determining the estimated arrival time of the vehicle at the charging location is based on the traffic along the route; and determining the estimated energy level of the vehicle at the estimated arrival time is based on the traffic along the route.

Clause 12: The method of any of clauses 1 through 11, wherein the route includes one or more waypoints between a current location of the vehicle and the charging location and is a direct route between a current location of the vehicle and the charging location without intervening waypoints.

Clause 13: The method of any of clauses 1 through 12, wherein the estimated arrival time of the vehicle at the charging location is based on a current time of day.

Clause 14: The method of any of clauses 1 through 13, further comprising: determining an actual arrival time of the vehicle at the charging location; and sending a notification based on the actual arrival time differing from the estimated arrival time by more than a threshold amount of time.

Clause 15: The method of any of clauses 1 through 14, further comprising: determining an actual energy level of the vehicle; and sending a notification based on the actual energy level differing from the estimated energy level by more than a threshold amount.

Clause 16: The method of any of clauses 1 through 15, further comprising sending a notification after determining that at least one charging session in the hybrid set of charging sessions will fail to meet a charging session objective, wherein the charging session objective comprises an energy level by a target time.

Clause 17: A processing system, comprising: a memory comprising computer-executable instructions; and a processor configured to execute the computer-executable instructions and cause the processing system to perform at least the following: estimate a vehicle return state based on telematics data associated with a vehicle; determine a future charging session for the vehicle based on the vehicle return state and one or more of the following: a vehicle attribute; a job attribute; or a station attribute; generate a hybrid set of charging sessions by adding the future charging session to a set of one or more current charging sessions; and process the hybrid set of charging sessions with a charging management algorithm to determine one or more charging session attributes for each charging session in the hybrid set of charging sessions.

Clause 18: The processing system of clause 17, wherein the vehicle return state comprises one or more attributes, including one or more of the following: an estimated arrival time of the vehicle at a charging location; or an estimated energy level of the vehicle at the estimated arrival time, wherein the estimated energy level comprises at least one of the following: a state of charge of an energy storage device in the vehicle, a number of kilowatt hours stored in an energy storage device in the vehicle, or the remaining range of the vehicle in miles or kilometers.

Clause 19: A non-transitory computer-readable medium comprising computer-executable instructions that, when executed by a processor of a processing system, cause the processing system to perform at least the following: estimate a vehicle return state based on telematics data associated with a vehicle; determine a future charging session for the vehicle based on the vehicle return state and one or more of the following: a vehicle attribute; a job attribute; or a station attribute; generate a hybrid set of charging sessions by adding the future charging session to a set of one or more current charging sessions; and process the hybrid set of charging sessions with a charging management algorithm to determine one or more charging session attributes for each charging session in the hybrid set of charging sessions.

Clause 20: The non-transitory computer-readable medium of clause 19, wherein the charging session attributes for each respective charging session in the hybrid set of charging sessions comprise one or more of the following: an estimated start time for the respective charging session; a target energy level at an end of the respective charging session; an estimated end time for the respective charging session; a charging station assignment for the respective charging session; a job identifier for the respective charging session; a maximum charging rate for the respective charging session; or a maximum charging voltage for each charging session.

### ADDITIONAL CONSIDERATIONS

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of managing charging of vehicles, comprising:
estimating a vehicle return state based on telematics data associated with a vehicle;
determining a future charging session for the vehicle based on the vehicle return state and one or more of the following:
a vehicle attribute;
a job attribute; or
a station attribute;
generating a hybrid set of charging sessions by adding the future charging session to a set of one or more current charging sessions; and
processing the hybrid set of charging sessions with a charging management algorithm to determine a charging session attribute for each charging session in the hybrid set of charging sessions.

2. The method of claim 1, wherein the vehicle return state comprises one or more attributes, including one or more of the following:
an estimated arrival time of the vehicle at a charging location; or
an estimated energy level of the vehicle at the estimated arrival time.

3. The method of claim 2, wherein the estimated energy level comprises at least one of the following: a state of charge of an energy storage device in the vehicle, a number of kilowatt hours stored in the energy storage device in the vehicle, or remaining range of the vehicle in miles or kilometers.

4. The method of claim 1, wherein the charging session attribute for each respective charging session in the hybrid set of charging sessions comprise one or more of the following:
an estimated start time for the respective charging session;
a target energy level at an end of the respective charging session;
an estimated end time for the respective charging session;
a charging station assignment for the respective charging session;
a job identifier for the respective charging session;
a maximum charging rate for the respective charging session; or
a maximum charging voltage for each charging session.

5. The method of claim 1, further comprising determining, using the charging management algorithm, one or more charging session attributes for each respective charging session in the hybrid set of charging sessions, including one or more of the following:
a time-series of charging rates during the respective charging session;
a total energy to be delivered during the respective charging session;
a difference between a target energy level and a final energy level during the respective charging session;
an estimated idle time of the vehicle during the respective charging session;
an estimated cost of the respective charging session; or
an indication of any station swap caused by the respective charging session.

6. The method of claim 1, wherein the charging management algorithm comprises at least one of the following: an optimization algorithm or an adaptive load management algorithm.

7. The method of claim 1, wherein the telematics data comprises one or more of the following:
a current location of the vehicle;
a current energy level of the vehicle;
a remaining range of the vehicle;
a current payload of the vehicle;
an ambient temperature around the vehicle;
a temperature setpoint of the interior of the vehicle; or
a driver profile associated with the vehicle.

8. The method of claim 1, further comprising assigning the vehicle to at least one of the following: a job or a charging station, based on output from the charging management algorithm.

9. The method of claim 1, further comprising conducting each charging session in the hybrid set of charging sessions according to the charging session attribute determined by the charging management algorithm.

10. The method of claim 2, further comprising:
determining a route for the vehicle to traverse to arrive at the charging location, wherein:
determining the estimated arrival time of the vehicle at the charging location is based on the route; and
determining the estimated energy level of the vehicle at the estimated arrival time is based on the route.

11. The method of claim 10, further comprising:
determining traffic along the route, wherein:
determining the estimated arrival time of the vehicle at the charging location is based on the traffic along the route; and
determining the estimated energy level of the vehicle at the estimated arrival time is based on the traffic along the route.

12. The method of claim 10, wherein the route includes one or more waypoints between a current location of the vehicle and the charging location and is a direct route between a current location of the vehicle and the charging location without intervening waypoints.

13. The method of claim 2, wherein the estimated arrival time of the vehicle at the charging location is based on a current time of day.

14. The method of claim 2, further comprising:
determining an actual arrival time of the vehicle at the charging location; and
sending a notification based on the actual arrival time differing from the estimated arrival time by more than a threshold amount of time.

15. The method of claim 2, further comprising:
determining an actual energy level of the vehicle; and
sending a notification based on the actual energy level differing from the estimated energy level by more than a threshold amount.

16. The method of claim 1, further comprising sending a notification after determining that at least one charging session in the hybrid set of charging sessions will fail to meet a charging session objective, wherein the charging session objective comprises an energy level by a target time.

17. A processing system, comprising:
a memory comprising computer-executable instructions; and
a processor configured to execute the computer-executable instructions and cause the processing system to perform at least the following:
estimate a vehicle return state based on telematics data associated with a vehicle;
determine a future charging session for the vehicle based on the vehicle return state and one or more of the following:
a vehicle attribute;
a job attribute; or
a station attribute;
generate a hybrid set of charging sessions by adding the future charging session to a set of one or more current charging sessions; and
process the hybrid set of charging sessions with a charging management algorithm to determine one or more charging session attributes for each charging session in the hybrid set of charging sessions.

18. The processing system of claim 17, wherein the vehicle return state comprises one or more attributes, including one or more of the following:
an estimated arrival time of the vehicle at a charging location; or
an estimated energy level of the vehicle at the estimated arrival time,
wherein the estimated energy level comprises at least one of the following: a state of charge of an energy storage device in the vehicle, a number of kilowatt hours stored in the energy storage device in the vehicle, or remaining range of the vehicle in miles or kilometers.

19. A non-transitory computer-readable medium comprising computer-executable instructions that, when executed by a processor of a processing system, cause the processing system to perform at least the following:
estimate a vehicle return state based on telematics data associated with a vehicle;
determine a future charging session for the vehicle based on the vehicle return state and one or more of the following:
a vehicle attribute;
a job attribute; or
a station attribute;
generate a hybrid set of charging sessions by adding the future charging session to a set of one or more current charging sessions; and
process the hybrid set of charging sessions with a charging management algorithm to determine one or more charging session attributes for each charging session in the hybrid set of charging sessions.

20. The non-transitory computer-readable medium of claim 19, wherein the charging session attribute for each respective charging session in the hybrid set of charging sessions comprise one or more of the following:
an estimated start time for the respective charging session;
a target energy level at an end of the respective charging session;
an estimated end time for the respective charging session;
a charging station assignment for the respective charging session;
a job identifier for the respective charging session;
a maximum charging rate for the respective charging session; or
a maximum charging voltage for each charging session.
